(19) United States
(12) Patent Application Publication
(10) Pub. No.: US 2023/0101381 A1
(43) Pub. Date: Mar. 30, 2023

(54) POSITIVE ACTIVE MATERIAL PRECURSOR FOR RECHARGEABLE LITHIUM BATTERY, METHOD FOR PREPARING POSITIVE ACTIVE MATERIAL USING THE PRECURSOR, AND POSITIVE ACTIVE MATERIAL FOR RECHARGEABLE LITHIUM BATTERY

(71) Applicant: SAMSUNG SDI CO., LTD., Yongin-si (KR)

(72) Inventors: Youngsun KONG, Yongin-si (KR); Seok Mun KANG, Yongin-si (KR); Wonmo SEONG, Yongin-si (KR); Dowook JUN, Yongin-si (KR); Naoyuki HASE, Yongin-si (KR)

(21) Appl. No.: 17/658,418

(22) Filed: Apr. 7, 2022

(30) Foreign Application Priority Data
Aug. 24, 2021 (KR) 10-2021-0111594
Oct. 15, 2021 (KR) 10-2021-0137718

(51) Int. Cl. H01M 4/525; H01M 4/505; H01M 4/36; H01M 4/04; H01M 10/0525

(52) U.S. Cl. CPC H01M 4/525; H01M 4/505; H01M 4/366; H01M 4/0471; H01M 10/0525; H01M 2004/028

(57) ABSTRACT

A positive active material precursor for a rechargeable lithium battery, a method for preparing a positive active material using the same, and a positive active material for a rechargeable lithium battery are provided. The positive active material precursor for a rechargeable lithium battery has a form of a core-shell particle including a core and a shell around the core, where the core includes a nickel-manganese-based composite hydroxide containing nickel and manganese, the shell includes a nickel-manganese-based composite hydroxide containing nickel, manganese, and a pillar element, and the pillar element includes at least one selected from Al, Mo, Ti, W, and Zr.

### CROSS-REFERENCE TO RELATED APPLICATIONS

This application claims priority to and the benefit of Korean Patent Application No. 10-2021-0111594, filed in the Korean Intellectual Property Office on Aug. 24, 2021, and Korean Patent Application No. 10-2021-0137718 filed in the Korean Intellectual Property Office on Oct. 15, 2021, the entire content of each of which is incorporated herein by reference.

### BACKGROUND

### 1. Field

One or more aspects of embodiments of the present disclosure relate to a positive active material precursor for a rechargeable lithium battery, a method for preparing a positive active material utilizing the same, and a positive active material for a rechargeable lithium battery.

### 2. Description of the Related Art

Portable information devices (such as a cell phone, a laptop, a smart phone, and/or the like) and/or an electric vehicles may utilize a rechargeable lithium battery having high energy density and/or easy portability as a driving power source. Recently, research has been actively conducted to utilize a rechargeable lithium battery with high energy density as a driving power source or power storage unit for hybrid and/or electric vehicles.

Various positive active materials have been investigated to realize rechargeable lithium batteries for these applications. Among them, ternary positive active materials (such as nickel-cobalt-manganese, nickel-cobalt-aluminum, and/or the like) are generally utilized to secure high capacity, high stability, a long cycle-life, and/or the like. However, because demand for positive active materials for electric vehicles and/or the like has rapidly increased, supply shortages of positive active materials containing cobalt (a rare metal) are expected, such that demand for positive active materials with no cobalt or a trace amount of cobalt is increasing. However, because cobalt plays a key role in the structure of the positive active materials, when the cobalt is removed or reduced therefrom, structural defects may occur, causing resistance increases and/or performance decreases (such as decreases in cycle-life, capacity, and/or efficiency).

In general, cobalt-free positive active materials in the related art do not have a layered structure, but instead have an olivine-based or spinel structure. Cobalt-free positive active materials with a layered structure in the related art exhibit deteriorated capacity and performance, compared with the analogous cobalt-containing positive active materials, and therefore draw little attention and are not commercially available. For example, in nickel-manganese layered positive active materials, because nickel ions are maintained as Ni²⁺ (e.g., Ni ions may be reduced and participate in unwanted side reactions), performance and stability tend to be deteriorated. Accordingly, further research is needed to develop a positive active material including no cobalt metal or a trace amount of cobalt metal and having the layered structure.

### SUMMARY

One or more aspects of embodiments of the present disclosure are directed toward a positive active material precursor capable of firmly maintaining a nickel-manganese-based layered structure even after repeated charges and discharges to therefore secure structural stability and realize excellent or suitable long-term cycle-life characteristics and/or high capacity, as well as a method for preparing a positive active material utilizing the same, and a positive active material for a rechargeable lithium battery also utilizing the same.

One or more embodiments of the present disclosure provide a positive active material precursor for a rechargeable lithium battery, the positive active material precursor having a form of a core-shell particle including a core and a shell around (e.g., surrounding) the core, wherein the core includes a nickel-manganese-based composite hydroxide containing nickel and manganese, the shell includes a nickel manganese-based composite hydroxide containing nickel, manganese, and a pillar element, and the pillar element includes at least one selected from aluminum (Al), molybdenum (Mo), titanium (Ti), tungsten (W), and zirconium (Zr).

One or more embodiments of the present disclosure provide a method of preparing a positive active material for a rechargeable lithium battery, where the method includes mixing the positive active material precursor with a lithium raw material, and performing heat treatment.

One or more embodiments of the present disclosure provides a positive active material for a rechargeable lithium battery, the positive active material having a form of a core-shell particle including a core and a shell around (e.g., surrounding) the core, wherein the core includes a lithium nickel manganese-based composite oxide containing lithium, nickel, and manganese, the shell includes a lithium nickel manganese-based composite oxide containing lithium, nickel, manganese, and a pillar element, and the pillar element includes at least one selected from Al, Mo, Ti, W, and Zr.

The positive active material precursor for a rechargeable lithium battery according to an embodiment and the positive active material utilizing the same may secure structural stability, because the nickel-manganese-based layered structure does not collapse but is firmly (e.g., stably) maintained even after repeated charges and discharges, and thus realize excellent or suitable cycle-life characteristics and/or high capacity.

### BRIEF DESCRIPTION OF THE DRAWINGS

FIG. 1 is a schematic view illustrating a rechargeable lithium battery according to an embodiment.

FIG. 2 is a scanning electron microscope (SEM) image of a cross-section of the positive active material precursor according to Example 1.

FIG. 3 is an SEM image of a cross-section of the positive active material according to Example 1.

FIG. 4 is an SEM image of a cross-section of a positive active material precursor according to Comparative Example 2.

FIG. 5 is an SEM image of a cross-section of the positive active material according to Comparative Example 2.

FIG. 6 is a graph for evaluating high-temperature cycle-life characteristics for the battery cells of Examples and Comparative Examples.

### DETAILED DESCRIPTION

Hereinafter, selected embodiments will be described in more detail so that those of ordinary skill in the art can easily implement them. However, this disclosure may be embodied in many different forms, and should not be construed as being limited to the example embodiments set forth herein.

The terminology used herein is descriptive, and is not intended to limit the present disclosure. Singular expressions such as “a,” “an,” and “the” are intended to include the plural forms as well, unless the context clearly dictates otherwise.

As used herein, “a combination thereof” may refer to a mixture, a laminate, a composite, a copolymer, an alloy, a blend, a reaction product, and/or the like of the indicated constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

As used herein, the terms “use,” “using,” and “used” may be considered synonymous with the terms “utilize,” “utilizing,” and “utilized,” respectively. As used herein, expressions such as “at least one of,” “one of,” and “selected from,” when preceding a list of elements, modify the entire list of elements and do not modify the individual elements of the list. For example, the expression “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items. The term “may” will be understood to refer to “one or more embodiments,” some of which include the described element and some of which exclude that element and/or include an alternate element. Similarly, alternative language such as “or” refers to “one or more embodiments,” each including a corresponding listed item.

In the drawings, the thickness of layers, films, panels, regions, etc., may be exaggerated for clarity, and like reference numerals designate like elements throughout the specification so that duplicative descriptions thereof may not be provided. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The term “layer” as used herein includes not only a shape formed on the whole surface when viewed from a plan view, but also a shape formed on a partial (e.g., portion of a) surface.

As referred to herein, the average particle diameter may be measured via any suitable method in the art, for example, by a particle size analyzer, or by a transmission electron micrograph (TEM) or a scanning electron micrograph (SEM). In some embodiments, it is possible to obtain an average particle diameter value by utilizing a dynamic light scattering method, performing data analysis, counting the number of particles for each particle size range, and calculating from this data. Unless otherwise defined, the average particle diameter may refer to the diameter of particles having a cumulative volume of 50 volume % in the particle size distribution (D50).

### Positive Active Material Precursor

In an embodiment, a positive active material precursor for a rechargeable lithium battery has a form of a core-shell particle including a core and a shell around (e.g., surrounding) the core, wherein the core includes a nickel-manganese-based composite hydroxide containing nickel and manganese, the shell includes a nickel manganese-based composite hydroxide containing nickel, manganese, and a pillar element, and the pillar element includes at least one selected from aluminum (Al), molybdenum (Mo), titanium (Ti), tungsten (W), and zirconium (Zr). Here, the pillar element may comprise Al, Mo, Ti, W, Zr, or a combination thereof, that is, the pillar element may comprise Al alone, Mo+Ti, Al+W+Zr, or the like.

The positive active material precursor may be mainly (e.g., primarily) composed of the nickel-manganese-based layered structure, and may include no cobalt or only a trace amount of cobalt (e.g., may substantially exclude cobalt). The positive active material may have secure structural stability and/or improved capacity and/or cycle-life characteristics by including the pillar element, which may serve as a pillar (e.g., may serve as a stable structural element) without being involved in charges and discharges (e.g., without being oxidized or reduced), into a crystal structure of a shell portion to strengthen a surface layer against common structural deterioration phenomena, so that the layered structure may not collapse even after a long cycle.

The core may not contain the pillar element (which includes at least one selected from Al, Mo, Ti, W, and Zr). When the pillar element is uniformly distributed inside the positive active material regardless of the core and the shell (e.g., simultaneously in both the core and the shell), the pillar element may just be mixed with other metal elements instead of properly functioning as a pillar to secure structural stability, and may not sufficiently suppress or reduce collapse of the nickel-manganese-based layered structure caused by charges and discharges, thereby resulting in deteriorated capacity and/or cycle-life characteristics. However, the positive active material precursor according to an embodiment and the positive active material utilizing the same each include the pillar element only in the shell and not in the core, (or only a trace amount in the core), such that the core/shell structure is maintained, the nickel-manganese-based layered structure is firmly maintained, and the capacity and/or cycle-life characteristics of a lithium battery including the positive active material are improved.

Synthetic methods in the related art for including additional elements have included a method of adding a raw material of Al, Mo, Ti, W, Zr, and/or the like to a positive active material precursor, and then firing the mixture to prepare a positive active material doped with the raw material. Depending on the synthetic methods and conditions utilized in the related art, the doping elements are either uniformly distributed in the crystal structure of the positive active material, or are not doped and remain coated on the surface to have a coating effect. Subsequently, during extended cycling or under high voltage driving, because the crystal structure of the positive active material is more rapidly deteriorated, the doping elements or the coating elements may rapidly lose their crystal structure stabilization function and have no effect. In contrast, the positive active material precursor according to an embodiment is a precursor in which a stabilizing element serves as a pillar in the shell, is introduced into and maintained in the shell without doping or coating other elements. A positive active material prepared by utilizing the same may thus be protected from degradation even after extended cycling or severely high voltage driving, and may thus maintain a spherical shape without particle breakage or structural collapse. For example, when this pillared structure is present in the shell alone rather than all over (e.g., doped throughout) the inside of the active material, the structure may substantially withstand contraction and expansion of the positive active material. A rechargeable lithium battery including this positive active material may thus exhibit excellent or suitable capacity retention ratio and/or high temperature cycle-life characteristics.

The term “pillared structure” refers to a structure in which pillar elements are located in a portion of metal sites of the layered structure (e.g., of the transition metal lattice sites in the crystal structure) and may also be called “a pillared layered structure”. This pillared structure may be a little rigid structure (e.g., may have some rigidity), and when this pillared structure is located in the shell, a phase transition (e.g., of the crystal lattice) may be suppressed or reduced during the charge and discharge, thereby well maintaining the physical structure.

A thickness of the shell may be about 20% to about 50%, for example about 20% to about 45%, about 20% to about 40%, about 25% to about 35%, about 30% to about 50%, or about 33% to about 50% of a radius of the core-shell particle. This shell thickness distinguishes the positive active material of the present disclosure from related art positive active materials with a general core/shell structure but a very thin shell thickness. In other words, the pillared structure in the positive active material precursor may be present from the surface to a depth (e.g., thickness portion) corresponding to about 20% to about 50% of the core-shell particle radius. In the positive active material precursor, when a thickness of a pillared area having the pillared structure, that is, a thickness of the shell portion is thinner or thicker than (e.g., outside) the above range, structural collapse due to the charge and discharge may not be effectively suppressed or reduced, thereby resulting in deteriorated capacity characteristics, cycle-life characteristics, and/or the like. For example, when the thickness of the shell is less than about 20%, the compositions of the core and the shell may mix together and become uniform, such that the pillar elements may not function as pillars.

In the positive active material precursor, a difference between a molar concentration of nickel based on the total metal in the core and a molar concentration of nickel based on the total metal in the shell may be greater than or equal to about 0 mol % and less than or equal to about 40 mol %, for example greater than or equal to about 0 mol % to less than about 30 mol %, greater than or equal to about 0 mol % and less than or equal to about 20 mol %, about 0 mol % to about 15 mol %, about 0 mol % to about 10 mol %, or about 0.1 mol % to about 5 mol %.

In some embodiments, a difference between a molar concentration of manganese based on the total metal in the core and a molar concentration of manganese based on the total metal in the shell may be greater than or equal to about 0 mol % and less than or equal to about 40 mol %, for example greater than or equal to about 0 mol % and less than about 30 mol %, greater than or equal to about 0 mol % and less than or equal to about 20 mol %, about 0 mol % to about 15 mol %, about 0 mol % to about 10 mol %, or about 0.1 mol % to about 5 mol %.

In the positive active material precursor, when the core and the shell have the above-described nickel and/or manganese concentration differences, the compositions of the core and the shell in the positive active material are not mixed up, and the pillared structure is maintained in the shell, thereby securing the structural stability of the positive active material and thus improving the capacity characteristics and/or cycle-life characteristics of a battery.

In the shell, a content (e.g., amount) of the pillar elements may be about 1 mol % to about 7 mol % based on the total metal content (e.g., amount) in the shell, for example, about 2 mol % to about 7 mol %, about 3 mol % to about 7 mol %, or about 4 mol % to about 7 mol %. Herein, the positive active material precursor may maintain a stable structure and improve capacity characteristics and cycle-life characteristics.

For example, the core may include nickel-manganese-based composite hydroxide represented by Chemical Formula 1, and the shell may include nickel-manganese-based composite hydroxide represented by Chemical Formula 2:

Niₐ₁Mn_{b1}M¹_{(1-a1-b1)}(OH)₂. Chemical Formula 1

In Chemical Formula 1, M¹ is at least one element selected from boron (B), barium (Ba), calcium (Ca), cerium (Ce), chromium (Cr), copper (Cu), fluorine (F), iron (Fe), magnesium (Mg), niobium (Nb), phosphorus (P), sulfur (S), silicon (Si), strontium (Sr), and vanadium (V), 0.6≤a1<1, and 0<b1≤0.4.

Niₓ₁Mn_{y1}M²_{z1}M³_{(1-x1-y1-z1)}(OH)₂. Chemical Formula 2

In Chemical Formula 2, M² is at least one pillar element selected from Al, Mo, Ti, W, and Zr, and M³ is at least one element selected from B, Ba, Ca, Ce, Cr, Cu, F, Fe, Mg, Nb, P, S, Si, Sr, and V, 0.6≤x1<0.99, 0<y1≤0.39, and 0.01≤z1≤0.07.

On the other hand, Chemical Formulae 1 and 2 satisfy |a1−x1|≤0.4, and |b1−y1|≤0.4. For example, |a1−x1|≤0.3, |a1−x1|≤0.2, |a1−x1|≤0.1, or |a1−x1|≤0.05, or for example, 0≤|a1−x1|≤0.2. In some embodiments, |b1−y1|≤0.3, |b1−y1|≤0.2, |b1−y1|≤0.1, or |b1−y1|≤0.05, or for example, 0≤|b1−y1|≤0.2. In other words, the nickel concentration difference in the core and the shell may be less than or equal to about 40 mol %, for example, less than or equal to about 30 mol %, less than or equal to about 20 mol %, less than or equal to about 15 mol %, less than or equal to about 10 mol %, or less than or equal to about 5 mol %, or for example, about 0 mol % to about 20 mol %. In some embodiments, the manganese concentration difference in the core and the shell may be less than or equal to about 40 mol %, for example, less than or equal to about 30 mol %, less than or equal to about 20 mol %, less than or equal to about 15 mol %, less than or equal to about 10 mol %, or less than or equal to about 5 mol %, or for example, about 0 mol % to about 20 mol %. When these ranges are satisfied, the compositions of the core and the shell in the positive active material are not mixed up, and the pillared structure is located in the shell alone to thereby secure structural stability and improve the capacity characteristics and/or the cycle-life characteristics of a battery.

In Chemical Formula 1, 0.6≤a1<1 and 0<b1≤0.4, for example, 0.7≤a1<1 and 0<b1≤0.3, 0.8<a1≤1 and 0<b1≤0.2, 0.9≤a1<1 and 0<b1≤0.1, 0.6≤a1≤0.9 and 0.1≤b1≤0.4, and/or the like, and M¹ may be a doping element in the core.

In Chemical Formula 2, z1 indicates a content (e.g., amount) of the pillar element in the shell, 0.01≤z1≤0.07, 0.02≤z1≤0.07, 0.03≤z1≤0.07, or 0.04≤z1≤0.07. In Chemical Formula 2, when z1 satisfies the ranges, the positive active material precursor may have a stable layered structure and may thus provide improved capacity characteristics, cycle-life characteristics, and/or the like of a battery. In other words, in Chemical Formula 2, 0.6≤x1<0.98, 0<y1≤0.38, and 0.02≤z1≤0.07, 0.6≤x1<0.97, 0<y1≤0.37, and 0.03≤z1≤0.07, 0.6≤x1<0.96, 0<y1≤0.36, and 0.04≤z1≤0.07, 0.6≤x1≤0.88, 0.1≤y1≤0.38, and 0.02≤z1≤0.07, or the like. In Chemical Formula 2, M³ may be a doping element in the shell.

The positive active material precursor may have a spherical or substantially spherical shape. The positive active material precursor may maintain a sphere shape in the positive active material after the firing. The positive active material precursor has a sphere shape and thus may not be broken or collapsed even after repeated charges and discharges, and may maintain a stable shape and thus exhibit low sheet resistance.

The positive active material precursor may have an average particle diameter (D50) of, for example, about 8 μm to about 15 μm, about 9 μm to about 14 μm, or about 10 μm to about 13 μm without a particular limit. Within the ranges, the positive active material precursor may exhibit high capacity and a high energy density. The average particle diameter may be measured by a particle size analyzer, and the term refers to the diameter of a particle having a volume of 50 volume % in a cumulative particle size distribution.

In the positive active material precursor, the core-shell particle may have the form of secondary particles in which a plurality of primary particles is agglomerated. This positive active material precursor may minimize or reduce lithium ion diffusion resistance and improve the cycle-life characteristics of a battery.

In addition, the positive active material precursor includes substantially no cobalt or includes cobalt in an amount of less than or equal to about 2 mol %, less than or equal to about 1 mol %, or less than or equal to about 0.1 mol % based on the total metal content (e.g., amount), but is not limited thereto. For example, the core may contain 0 mol % to 1 mol %, or 0 mol % to 0.5 mol % of cobalt based on the total metal content of the core.

### Method of Preparing Positive Active Material

In an embodiment, a method of preparing a positive active material for a rechargeable lithium battery includes mixing the aforementioned positive active material precursor with a lithium raw material and performing heat treatment.

The lithium raw material may be or include, for example, Li₂CO₃, LiOH, a hydrate thereof, or a combination thereof as a lithium source of the positive active material.

A ratio of the number of moles of lithium in the lithium raw material to the number of moles of metal in the positive active material precursor may be, for example, greater than or equal to about 0.8, greater than or equal to about 0.85, greater than or equal to about 0.9, greater than or equal to about 0.95, or greater than or equal to about 1.0 and less than or equal to about 1.8, less than or equal to about 1.2, less than or equal to about 1.1, or less than or equal to about 1.05.

The heat treatment may be performed under an oxidizing gas atmosphere, for example, an oxygen atmosphere or an air atmosphere. In some embodiments, the heat treatment may be performed, for example, about 700° C. to about 1000° C., or about 750° C. to about 900° C., and for example, for about 5 hours to about 15 hours.

### Positive Active Material

In an embodiment, a positive active material for a rechargeable lithium battery having a form of a core-shell particle includes a core and a shell around (e.g., surrounding) the core, wherein the core includes a lithium nickel manganese-based composite oxide containing lithium, nickel, and manganese, the shell includes a lithium nickel manganese-based composite oxide containing lithium, nickel, manganese, and a pillar element, and the pillar element includes at least one selected from Al, Mo, Ti, W, and Zr.

The above positive active material precursor is utilized to prepare a positive active material with the same core-shell structure so that the compositions of the core and the shell are not mixed together, and the pillared structure may be present in the shell alone, without being included or being included in a very small amount in the core. The positive active material with this structure has a nickel-manganese-based layered structure including substantially no cobalt or only a trace amount of cobalt, and may thus maintain a very stable structure even after repeated charges and discharges and thereby realize high capacity and/or excellent or suitable cycle-life characteristics.

A content (e.g., amount) of the pillar element included in the shell in the positive active material may be about 1 mol % to about 7 mol %, for example, about 2 mol % to about 7 mol %, about 3 mol % to about 7 mol %, or about 4 mol % to about 7 mol % based on the total content (e.g., amount) of metals excluding lithium in the shell. In contrast, a content (e.g., amount) of the pillar element included in the core may be about 0 mol % to less than about 2 mol %, for example, about 0 mol % to less than about 1 mol %, about 0 mol % to about 0.9 mol %, about 0 mol % to about 0.7 mol %, about 0 mol % to about 0.5 mol %, about 0 mol % to about 0.3 mol %, about 0 mol % to about 0.1 mol %, about 0.1 mol % to about 0.9 mol %, and/or the like, based on the total content (e.g., amount) of metals excluding lithium in the core. In other words, the pillar element is substantially not present or is included only in a trace amount in the core. When the pillar element is uniformly distributed in the positive active material, the pillar element may not actually serve as a pillar and may insufficiently suppress or reduce the layered structure from collapse during the long cycle or high voltage driving, but the positive active material according to an embodiment has a pillared structure formed in the shell portion which keeps the structure stable without cracks or collapse even under severe conditions, accordingly enabling excellent or suitable cycle-life and/or capacity characteristics. A value obtained by subtracting a content of the pillar element in the core from the content of the pillar element in the shell may be about 1 mol % to about 7 mol %.

In the positive active material, a thickness of the shell is not thinner than that of related art positive active materials having a core-shell structure, but is about 20% to about 50% of a core-shell particle radius, for example, about 20% to about 45%, about 20% to about 40%, about 25% to about 35%, about 30% to about 50%, about 33% to about 50%, and/or the like. In other words, the pillared structure may be present from the surface of the positive active material through a thickness corresponding to about 20% to about 50% of the particle radius. When the shell thickness is thinner or thicker than (e.g., outside) the above thickness ranges, structural collapse caused by charges and discharges may not be effectively suppressed or reduced. For example, when the shell thickness is less than about 20%, the compositions of the core and the shell in the positive active material may mix together and become substantially uniform, and the pillar elements may not serve as pillars. However, when the shell thickness satisfies the above ranges, the nickel-manganese-based layered structure may be stably maintained even during long-term cycling, and accordingly, capacity and/or cycle-life characteristics may be improved.

In the positive active material, a nickel concentration of the core may be substantially equal or similar to that of the shell, and also, a manganese concentration of the core also may be substantially equal or similar to that of the shell. This positive active material is distinguished from a positive active material in which a nickel-rich layer or a manganese-rich layer is, for example, formed on the surface or inside of the positive active material. The aforementioned positive active material precursor may be utilized to realize a positive active material having similar nickel and manganese concentrations between the core and the shell with the pillar elements remaining in the shell alone. When there is a large difference in the nickel or manganese concentration of the core and the shell of the positive active material, the compositions of the core and the shell may mix together so that the active material has a substantially spatially uniform composition, and the pillar elements (when initially present) may not (e.g., no longer) serve as pillars. In contrast, the positive active material according to an embodiment has similar nickel and manganese concentrations between the core and the shell so that the core and shell compositions do not mix, and thus a core-shell structure with the pillar elements only in the shell to serve as pillars is maintained.

For example, a difference between a molar concentration of nickel based on the total metal excluding lithium in the core and a molar concentration of nickel based on the total metal excluding lithium in the shell may be greater than or equal to about 0 mol % and less than or equal to about 10 mol %, for example greater than or equal to about 0 mol % and less than about 10 mol %, about 0 mol % to about 9 mol %, about 0 mol % to about 8 mol %, about 0 mol % to about 7 mol %, or about 0.1 mol % to about 6 mol %.

In some embodiments, a difference between a molar concentration of manganese based on the total metal excluding lithium in the core and the molar concentration of manganese based on the total metal excluding lithium in the shell may be greater than or equal to about 0 mol % and less than or equal to about 5 mol %, for example greater than or equal to about 0 mol % and less than 5 mol %, 0 mol % to 4 mol %, about 0 mol % to about 3 mol %, about 0 mol % to about 2 mol %, or about 0.1 mol % to about 1.5 mol %.

When the positive active material has a nickel or manganese concentration difference between the core and the shell, the compositions of the core and the shell in the positive active material may not mix together and the pillar structure may be maintained in the shell alone, accordingly, structure stability may be secured, thus providing improved capacity and/or cycle-life characteristics in a battery.

In the positive active material according to embodiments, the core may include a lithium-nickel-manganese-based composite oxide represented by Chemical Formula 11, and the shell may include a lithium-nickel-manganese-based composite oxide represented by Chemical Formula 12.

LiNiₐMn_{b}M¹¹_{c}M¹²_{(1-a-b-c)}O₂. Chemical Formula 11

In Chemical Formula 11, M¹¹ is a pillar element that is at least one selected from Al, Mo, Ti, W, and Zr, M¹² is at least one element selected from B, Ba, Ca, Ce, Cr, Cu, F, Fe, Mg, Nb, P, S, Si, Sr, and V, 0.6≤a<1, 0<b≤0.4, and 0≤c<0.02.

LiNiₓMn_{y}M¹³_{z}M¹⁴_{(1-x-y-z)}O₂. Chemical Formula 12

In Chemical Formula 12, M¹³ is a pillar element that is at least one selected from Al, Mo, Ti, W, and Zr, M¹⁴ is at least one element selected from B, Ba, Ca, Ce, Cr, Cu, F, Fe, Mg, Nb, P, S, Si, Sr, and V, 0.6≤x<0.99, 0<y≤0.39, and 0.01≤z≤0.07.

In Chemical Formula 11 and Chemical Formula 12, |a−x|≤0.1, and |b−y|≤0.05. For example, |a−x|≤0.1, |a−x|≤0.09, |a−x|≤0.08, |a−x|≤0.07, or |a−x|≤0.06, for example, 0≤|a−x|≤0.1 or 0<|a−x|≤0.1. In some embodiments, |b−y|≤0.05, |b−y|≤0.04, |b−y|≤0.03, |b−y|≤0.02, or |b−y|≤0.015, for example, 0≤|b−y|≤0.05 or 0<|b−y|≤0.05. In other words, a nickel concentration difference between the core and the shell may be less than or equal to about 10 mol %, for example, less than or equal to about 9 mol %, less than or equal to about 8 mol %, less than or equal to about 7 mol %, or less than or equal to about 6 mol %, for example, about 0 mol % to about 10 mol %. The manganese concentration difference between the core and the shell may be less than or equal to about 5 mol %, for example, less than or equal to about 4 mol %, less than or equal to about 3 mol %, less than or equal to about 2 mol %, or less than or equal to about 1.5 mol %, for example, about 0 mol % to about 5 mol %. When the ranges are satisfied, the compositions of the core and the shell in the positive active material are not mixed, and the pillared structure is located only in the shell, securing stability of the structure and thus improving capacity characteristics and cycle-life characteristics of a battery.

In Chemical Formula 11, 0.6≤a<1, 0<b≤0.4, 0≤c<0.02, for example, 0.7≤a<1, 0<b≤0.3, 0≤c<0.02, for example, 0.8≤a<1, 0<b≤0.2, 0≤c<0.02, or 0.9≤a<1, 0<b≤0.1, 0≤c<0.02, 0.6≤a≤0.9, 0.1≤b≤0.4, 0≤c<0.02, or the like. In some embodiments, 0≤c<0.01 or 0<c<0.01.

In Chemical Formula 12, z indicates a content (e.g., amount) of the pillar element in the shell, with 0.01≤z≤0.07, 0.02≤z≤0.07, 0.03≤z≤0.07, or 0.04≤z≤0.07. When z in Chemical Formula 12 satisfies the ranges, the positive active material may secure stability of the layered structure and thus improve capacity characteristics, cycle-life characteristics, and/or the like of a battery. In other words, in Chemical Formula 12, 0.6≤x<0.98, 0<y≤0.38, 0.02≤z≤0.07, for example, 0.6≤x<0.97, 0<y≤0.37, 0.03≤z≤0.07, or 0.6≤x<0.96, 0<y≤0.36, 0.04≤z≤0.07, 0.6≤x≤0.88, 0.1≤y≤0.38, 0.02≤z≤0.07, or the like.

The positive active material may have (e.g., may be in a particle form having) a spherical or substantially spherical shape. Accordingly, the positive active material may not be broken or collapsed but maintain a stable shape and exhibit low sheet resistance even after repeated charges and discharges.

The positive active material may, for example, have (e.g., may be in a particle form having) an average particle diameter (D₅₀) of about 8 μm to about 15 μm, about 9 μm to about 14 μm, about 10 μm to about 13 μm, and/or the like without a particular limit. Within the ranges, the positive active material may exhibit high capacity and high energy density. The average particle diameter may be measured by a particle size analyzer and refer to a diameter of particle having a cumulative volume of 50 volume % in the particle size distribution.

In the positive active material, the core-shell particles may be in the form of secondary particles in which a plurality of primary particles is agglomerated. In some embodiments, the positive active material may include irregular pores inside the core-shell particle. This positive active material may minimize or reduce migration (e.g., diffusion) resistance of lithium ions and thus reduce resistance and/or improve cycle-life characteristics.

In some embodiments, the positive active material may not contain cobalt or may contain less than or equal to about 2 mol %, less than or equal to about 1 mol %, or less than or equal to about 0.1 mol % of cobalt based on the total content (e.g., amount) of metals in the positive active material, but is not limited thereto. For example, the positive active material may be a cobalt-free layered structure positive active material.

### Positive Electrode

In an embodiment, a positive electrode for a rechargeable lithium battery including the aforementioned positive active material is provided. The positive electrode for a rechargeable lithium battery may include a current collector and a positive active material layer on the current collector, and the positive active material layer may include a positive active material and may further include a binder and/or a conductive material.

The binder improves binding properties of positive active material particles with one another and with a current collector. Examples thereof may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but is not limited thereto.

The content (e.g., amount) of the binder in the positive active material layer may be about 1 wt % to about 5 wt % based on the total weight of the positive active material layer.

The conductive material is included to provide electrode conductivity. Any electrically conductive material may be utilized as a conductive material unless it causes an unwanted chemical change. Examples of the conductive material may include a carbon-based material (such as natural graphite, artificial graphite, carbon black, acetylene black, ketjen black, a carbon fiber, carbon nanotube, and/or the like); a metal-based material of a metal powder and/or a metal fiber including copper, nickel, aluminum, silver, and/or the like; a conductive polymer (such as a polyphenylene derivative); or a mixture thereof.

The content (e.g., amount) of the conductive material in the positive active material layer may be about 1 wt % to about 5 wt % based on the total weight of the positive active material layer.

An aluminum foil may be utilized as the positive current collector, but is not limited thereto.

### Negative Electrode

A negative electrode for a rechargeable lithium battery includes a current collector and a negative active material layer on the current collector. The negative active material layer may include a negative active material, and may further include a binder and/or a conductive material.

The negative active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative active material. The crystalline carbon may be non-shaped (e.g., have no set shape), or may be sheet, flake, spherical, and/or fiber shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be or include a Si-based negative active material or a Sn-based negative active material. The Si-based negative active material may include silicon, a silicon-carbon composite, SiOₓ (0<x<2), a Si-Q alloy (wherein Q is an alkali metal, an alkaline-earth metal, a Group 13 element, a Group 14 element excluding Si, a Group 15 element, a Group 16 element, a transition metal, a rare earth element, and a combination thereof), and the Sn-based negative active material may include Sn, SnO₂, Sn—R alloy (wherein R is an alkali metal, an alkaline-earth metal, a Group 13 element, a Group 14 element excluding Sn, a Group 15 element, a Group 16 element, a transition metal, a rare earth element, and a combination thereof). At least one of these materials may be mixed with SiO₂. The elements Q and R may be selected from magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (TI), germanium (Ge), phosphorus (P), arsenic (As), antimony (Sb), bismuth (Bi), sulfur (S), selenium (Se), tellurium (Te), polonium (Po), and combinations thereof.

The silicon-carbon composite may be or include, for example, a silicon-carbon composite including a core including crystalline carbon and silicon particles and an amorphous carbon coating layer disposed on the surface of the core. The crystalline carbon may be or include artificial graphite, natural graphite, or a combination thereof. The amorphous carbon precursor may be a coal-based pitch, mesophase pitch, petroleum-based pitch, coal-based oil, petroleum-based heavy oil, or a polymer resin (such as a phenol resin, a furan resin, and/or a polyimide resin). In this case, the content (e.g., amount) of silicon may be about 10 wt % to about 50 wt % based on the total weight of the silicon-carbon composite. In some embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In some embodiments, a thickness of the amorphous carbon coating layer may be about 5 nm to about 100 nm. An average particle diameter (D50) of the silicon particles may be about 10 nm to about 20 μm. The average particle diameter (D50) of the silicon particles may be about 10 nm to about 200 nm. The silicon particles may be present in an oxidized form, and in this case, an atomic content (e.g., amount) ratio of Si:O in the silicon particles (reflecting a degree of oxidation) may be about 99:1 to about 33:67. The silicon particles may be SiOₓ particles, and in this case, the range of x in SiOₓ may be greater than about 0 and less than about 2. In the present specification, unless otherwise defined, an average particle diameter (D50) indicates the diameter of particles where an accumulated volume is about 50 volume % in a particle size distribution.

The Si-based negative active material or Sn-based negative active material may be mixed with the carbon-based negative active material. When the Si-based negative active material or Sn-based negative active material and the carbon-based negative active material are mixed and utilized, the mixing ratio may be a weight ratio of about 1:99 to about 90:10.

In the negative active material layer, the negative active material may be included in an amount of about 95 wt % to about 99 wt % based on the total weight of the negative active material layer.

In an embodiment, the negative active material layer further includes a binder, and may optionally further include a conductive material. The content (e.g., amount) of the binder in the negative active material layer may be about 1 wt % to about 5 wt % based on the total weight of the negative active material layer. In some embodiments, when the conductive material is further included, the negative active material layer may include about 90 wt % to about 98 wt % of the negative active material, about 1 wt % to about 5 wt % of the binder, and about 1 wt % to about 5 wt % of the conductive material.

The binder serves to adhere the negative active material particles to each other and also to adhere the negative active material to the current collector. The binder may be a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, and/or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and combinations thereof.

When a water-soluble binder is utilized as the negative electrode binder, a cellulose-based compound capable of imparting viscosity may be further included as a thickener. As the cellulose-based compound, one or more of carboxymethyl cellulose, hydroxypropylmethyl cellulose, methyl cellulose, and alkali metal salts thereof may be mixed and utilized. As the alkali metal, Na, K, or Li may be utilized. The amount of the thickener utilized may be about 0.1 parts by weight to about 3 parts by weight based on 100 parts by weight of the negative active material.

The conductive material is included to provide electrode conductivity. Any electrically conductive material may be utilized as a conductive material unless it causes an unwanted chemical change. Examples of the conductive material may include a carbon-based material (such as natural graphite, artificial graphite, carbon black, acetylene black, ketjen black, a carbon fiber, carbon nanotube, and/or the like); a metal-based material of a metal powder and/or a metal fiber including copper, nickel, aluminum silver, and/or the like; a conductive polymer (such as a polyphenylene derivative); and/or a mixture thereof.

The negative current collector may include one selected from a copper foil, a nickel foil, a stainless steel foil, a titanium foil, a nickel foam, a copper foam, a polymer substrate coated with a conductive metal, and combinations thereof.

### Rechargeable Lithium Battery

In an embodiment, a rechargeable lithium battery includes a positive electrode including the aforementioned positive active material and negative electrode, a separator between the positive electrode and the negative electrode, and an electrolyte (e.g., impregnated in the separator).

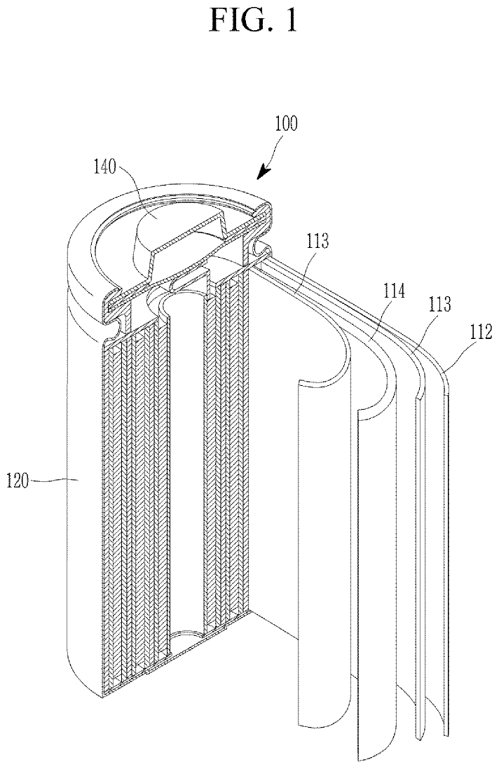

FIG. 1 is a schematic view illustrating a rechargeable lithium battery according to an embodiment. Referring to FIG. 1, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be or include a carbonate-based, ester-based, ether-based, ketone-based, or alcohol-based solvent, or an aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In some embodiments, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In some embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

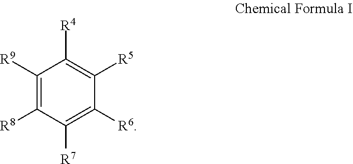

In Chemical Formula I, R⁴ to R⁹ may each independently be the same or different, and are selected from hydrogen, a halogen, a C1 to C10 alkyl group, a C1 to C10 haloalkyl group, and a combination thereof.

Non-limiting examples of the aromatic hydrocarbon-based solvent may be or include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate and/or an ethylene carbonate-based compound of Chemical Formula II as an additive in order to improve cycle-life of a battery.

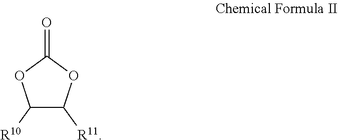

In Chemical Formula II, R¹⁰ and R¹¹ may each independently be the same or different, and may be selected from hydrogen, a halogen, a cyano group, a nitro group, and fluorinated C1 to C5 alkyl group, provided that at least one of R¹⁰ and R¹¹ is selected from a halogen, a cyano group, a nitro group, and a fluorinated C1 to C5 alkyl group, but of R¹⁰ and R¹¹ are not both (e.g., simultaneously) hydrogen.

Examples of the ethylene carbonate-based compound may be or include difluoroethylene carbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving cycle-life may be utilized within an appropriate or suitable range.

The lithium salt dissolved in the non-aqueous organic solvent supplies lithium ions in a battery, enables basic operation of a rechargeable lithium battery, and improves transportation of the lithium ions between positive and negative electrodes.

Examples of the lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer in a range of 1 to 20, lithium difluorobis(oxalato) phosphate, LiCl, LiI, LiB(C₂O₄)₂ (lithium bis(oxalato) borate, LiBOB), and lithium difluoro(oxalato)borate (LiDFOB).

The lithium salt may be utilized in a concentration of about 0.1 M to about 2.0 M. When the lithium salt is included at the above concentration range, an electrolyte may have excellent or suitable performance and/or lithium ion mobility due to optimal or suitable electrolyte conductivity and viscosity.

The separator 113 separates a positive electrode 114 and a negative electrode 112 and provides a transporting passage for lithium ions, and may be any generally-utilized separator in a lithium ion battery. For example, it may have low resistance to ion transport and/or excellent or suitable impregnation for an electrolyte. The material for the separator may include or be selected from a glass fiber, polyester, Teflon, polyethylene, polypropylene, polytetrafluoroethylene, or a combination thereof. It may have a form of a non-woven fabric or a woven fabric. For example a polyolefin-based polymer separator (such as polyethylene and polypropylene) may be mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and/or lithium polymer batteries depending on the presence of a separator and the type or kind of electrolyte utilized therein. The rechargeable lithium batteries may have a variety of shapes and sizes, such as cylindrical, prismatic, coin, or pouch-type or format batteries, and may be thin film batteries or may be rather bulky in size. Structures and manufacturing methods for lithium ion batteries pertaining to this disclosure are well known in the art.

The rechargeable lithium battery according to an embodiment may be utilized in an electric vehicle (EV), a hybrid electric vehicle (such as a plug-in hybrid electric vehicle (PHEV)), and/or a portable electronic device, because it implements a high capacity and has excellent or suitable storage stability, cycle-life characteristics, and/or high rate characteristics at high temperatures.

Hereinafter, examples of the present disclosure and comparative examples are described. It is to be understood, however, that the examples are for the purpose of illustration, and are not to be construed as limiting the present disclosure.

### Example 1

### (1) Preparation of Positive Active Material Precursor

A core was synthesized by utilizing nickel sulfate and manganese sulfate as metal raw materials in a co-precipitation method. First, ammonia water with a concentration of 0.4 mol/L was added to a reactor. The metal raw materials at 9 L/hr and ammonia water at 1 L/hr were concurrently (e.g., simultaneously) injected at a stirring power of 3.5 kW/m³ at 40° C. Subsequently, NaOH was added thereto to maintain pH. The reaction was performed within a range of pH 11.0 to pH 12.0 for 16 hours or more, synthesizing a core of Ni_{0.80}Mn_{0.20}(OH)₂.

Subsequently, a shell around (e.g., surrounding) the core was synthesized by utilizing nickel sulfate, manganese sulfate, and aluminum hydroxide as metal raw materials. Into the obtained core, the metal raw materials at 5 L/hr and ammonia water at 0.5 L/hr were concurrently (e.g., simultaneously) injected. Subsequently, NaOH was injected thereinto, and then reacted therewith within a range of pH 11.0 to 12.0 for 6 hours, synthesizing a shell of Ni_{0.70}Mn_{0.25}Al_{0.05}(OH)₂ according to Example 1.

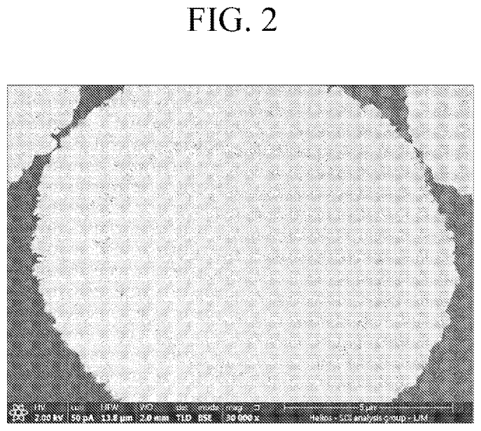

A reaction product therefrom was washed and then hot air-dried at about 150° C. for 24 hours, preparing a positive active material precursor having a core-shell structure and an average particle diameter (D50) of about 12 μm. FIG. 2 is a scanning electron microscope image of a cross-section of the positive active material precursor prepared in Example 1. Referring to FIG. 2, the synthesized positive active material precursor has a spherical-shaped core-shell structure and a shell having a thickness within a range of 20% to 50% of the core-shell particle radius.

### (2) Preparation of Positive Active Material

A positive active material with a core-shell structure was synthesized by mixing the obtained positive active material precursor and lithium hydroxide in a mole ratio of 1:1 and heat-treating the mixture under an oxygen atmosphere at about 800° C. for 6 hours.

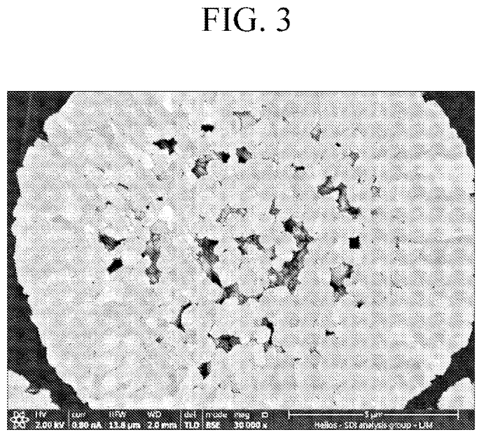

FIG. 3 is a scanning electron microscope image showing a cross-section of the positive active material prepared in Example 1. Referring to FIG. 3, the synthesized positive active material has a spherical shaped core-shell structure and a shell thickness within a range of 20% to 50% of the core-shell particle radius.

### (3) Manufacture of Positive Electrode

95 wt % of the obtained positive active material, 3 wt % of a polyvinylidene fluoride binder, and 2 wt % of a carbon nanotube conductive material were mixed in an N-methylpyrrolidone solvent, preparing positive active material slurry. The positive active material slurry was coated on an aluminum current collector, and then dried and compressed, preparing a positive electrode.

### (4) Manufacture of Rechargeable Lithium Battery Cell

A coin half-cell was manufactured by disposing a separator having a polyethylene polypropylene multilayer structure between the manufactured positive electrode and a lithium metal counter electrode, and injecting an electrolyte solution in which 1.0 M LiPF₆ lithium salt was added to a solvent in which ethylene carbonate and diethyl carbonate are mixed in a volume ratio of 50:50.

### Comparative Example 1

A positive active material precursor, a positive active material, a positive electrode, and a battery cell were prepared according to substantially the same method as Example 1, except that a shell of a Ni_{0.70}Mn_{0.30}(OH)₂ composition is formed without utilizing an aluminum raw material during the manufacture of the positive active material precursor.

### Comparative Example 2

A positive active material precursor is prepared according to the same method as Comparative Example 1, and then, a positive active material, a positive electrode, and a battery cell were manufactured according to the same method as Comparative Example 1 except that when the positive active material precursor and lithium hydroxide are mixed, 5 mol % of aluminum oxide is added thereto based on the total amount of the positive active material precursor.

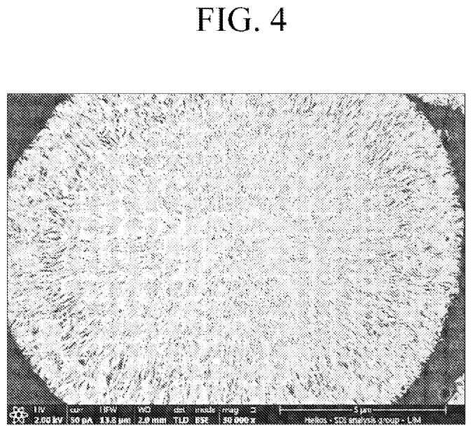

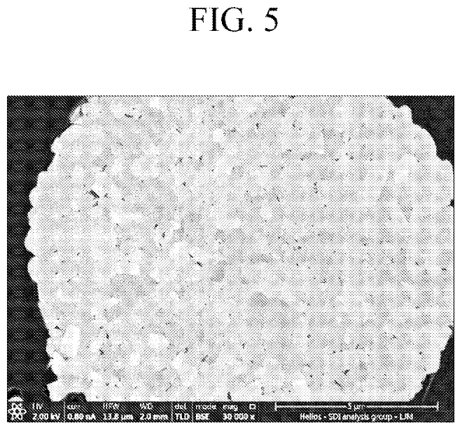

FIG. 4 is a scanning electron microscope image of a cross-section of the positive active material precursor of Comparative Example 2, and FIG. 5 is a scanning electron microscope image of a cross-section of the positive active material of Comparative Example 2. Referring to FIGS. 4 and 5, the core-shell structure of the positive active material of FIG. 5 is not well maintained, and aluminum is uniformly distributed inside the positive active material regardless of the core and the shell.

### Evaluation Example 1: Element Analysis

The positive active materials synthesized according to Example 1 and Comparative Examples 1 and 2 were analyzed with respect to the elemental composition of the core and the shell through inductively coupled plasma (ICP) spectroscopic analysis of the cross-section of the positive active material, and the results are shown in Table 1. In Table 1, the units of each value is mol %.

TABLE 1

| | | Comparative | | | | Comparative | |
|---|---|---|---|---|---|---|---|
| | | Example 1 | | Example 1 | | Example 2 | |
| | | core | shell | core | shell | core | shell |
| Composition | Ni | 80 | 70 | 78 | 72 | 76 | 75 |
| (mol %) | Mn | 20 | 30 | 21.9 | 23 | 20 | 20 |
| | Al | — | — | 0.1 | 5 | 4 | 5 |

Referring to Table 1, the positive active material of Example 1 includes a pillar element of Al in a trace amount of 1 mol % or less in the core and in an amount of about 5 mol % in the shell. In Example 1, a nickel concentration difference between the core and the shell is 6 mol % or so, and a manganese concentration difference between the core and the shell is 1.1 mol % or so. On the other hand, the positive active material of Comparative Example 2 includes aluminum uniformly distributed almost in substantially the same amount in the core and the shell and thus has no nickel concentration difference between the core and the shell and also no manganese concentration difference between the core and the shell.

### Evaluation Example 2: High-Temperature Cycle-Life Characteristics

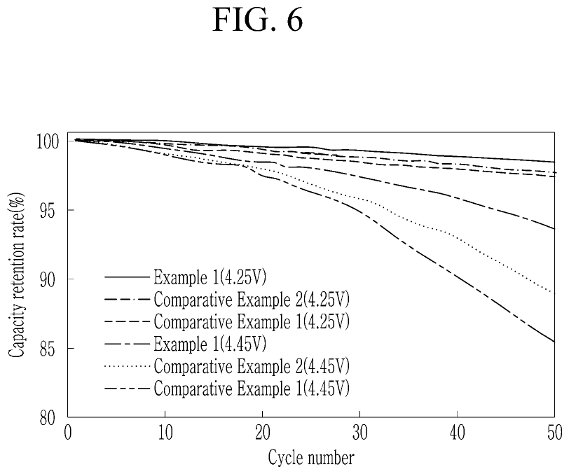

The coin half-cells according to Example 1 and Comparative Examples 1 and 2 were charged at a constant current (0.2C) and a constant voltage (4.25 V, cut-off at 0.05C), paused for 10 minutes, and discharged to 3.0 V at a constant current (0.2C) to perform initial charge and discharge. Subsequently, the cells were charged and discharged 50 times at 1C at 45° C. to measure discharge capacity, and then, capacity retention ratio was evaluated by a ratio (%) of the 50^{th} discharge capacity relative to the initial discharge capacity, which are shown in FIG. 6 and Table 2.

The cycle-life characteristics of the cells were additionally evaluated under the same charging conditions but at a constant voltage of 4.45 V, and the results are shown in FIG. 6 and Table 2.

TABLE 2

| 50th high-temperature | Example | Comparative | Comparative |
|---|---|---|---|
| cycle-life (%) | 1 | Example 1 | Example 2 |
| 4.25 V | 98.4 | 97.3 | 97.6 |
| 4.45 V | 93.3 | 84.3 | 88.9 |

Referring to Table 2 and FIG. 6, when charged at 4.25 V, the cell according to Example 1 exhibits relatively excellent or improved cycle-life characteristics, compared with the cells according to Comparative Examples 1 and 2, and when charged at 4.45 V, Example 1 exhibits significantly excellent or improved cycle-life characteristics, compared with the cells according to Comparative Examples 1 and 2.

Terms such as “substantially,” “about,” and “˜” are used as terms of approximation and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

While this disclosure has been described in connection with what is presently considered to be practical example embodiments, it is to be understood that the present disclosure is not limited to the disclosed embodiments. In contrast, it is intended to cover various modifications and equivalent arrangements included within the spirit and scope of the appended claims and equivalents thereof.

### DESCRIPTION OF SOME OF THE SYMBOLS

| | | | |
|---|---|---|---|
| 100: | rechargeable lithium battery | 112: | negative electrode |
| 113: | separator | 114: | positive electrode |
| 120: | battery case | 140: | sealing member |

What is claimed is:

1. A positive active material precursor for a rechargeable lithium battery,
the positive active material precursor having a form of a core-shell particle comprising a core and a shell around the core,
wherein the core comprises a first nickel-manganese-based composite hydroxide comprising nickel and manganese,
the shell comprises a second nickel-manganese-based composite hydroxide comprising nickel, manganese, and a pillar element, and
the pillar element comprises at least one selected from the group consisting of Al, Mo, Ti, W, and Zr.

2. The positive active material precursor of claim 1, wherein the core does not comprise the pillar element.

3. The positive active material precursor of claim 1, wherein the core comprises about 0 mol % to about 1 mol % of cobalt based on the total content of metals in the core.

4. The positive active material precursor of claim 1, wherein a content of the pillar element in the shell is about 1 mol % to about 7 mol % based on 100 mol % of the total metal in the shell.

5. The positive active material precursor of claim 1, wherein a thickness of the shell is about 20% to about 50% of a radius of the core-shell particle.

6. The positive active material precursor of claim 1, wherein:
a difference between a molar concentration of nickel based on the total metal in the core and a molar concentration of nickel based on the total metal in the shell is greater than or equal to about 0 mol % and less than or equal to about 40 mol %, and
a difference between a molar concentration of manganese based on the total metal in the core and a molar concentration of manganese based on the total metal in the shell is greater than or equal to about 0 mol % and less than or equal to about 40 mol %.

7. The positive active material precursor of claim 1, wherein:
a difference between a molar concentration of nickel based on the total metal in the core and a molar concentration of nickel based on the total metal in the shell is greater than or equal to about 0 mol % and less than or equal to about 20 mol %, and
a difference between a molar concentration of manganese based on the total metal in the core and a molar concentration of manganese based on the total metal in the shell is greater than or equal to about 0 mol % and less than or equal to about 20 mol %.

8. The positive active material precursor of claim 1, wherein:
the core comprises a nickel-manganese-based composite hydroxide represented by Chemical Formula 1,
the shell comprises a nickel-manganese-based composite hydroxide represented by Chemical Formula 2:
Niₐ₁Mn_{b1}M¹_{(1-a1-b1)}(OH)₂, Chemical Formula 1
wherein, in Chemical Formula 1, M¹ is at least one element selected from the group consisting of B, Ba, Ca, Ce, Cr, Cu, F, Fe, Mg, Nb, P, S, Si, Sr, and V, 0.6≤a1<1, and 0<b1≤0.4,
Niₓ₁Mn_{y1}M²_{z1}M³_{(1-x1-y1-z1)}(OH)₂, Chemical Formula 2
wherein, in Chemical Formula 2, M² is at least one pillar element selected from the group consisting of Al, Mo, Ti, W, and Zr, and M³ is at least one element selected from B, Ba, Ca, Ce, Cr, Cu, F, Fe, Mg, Nb, P, S, Si, Sr, and V, 0.6≤x1<0.99, 0<y1≤0.39, and 0.01≤z1≤0.07, and
wherein, in Chemical Formula 1 and Chemical Formula 2, |a1−x1|≤0.4 and |b1−y1|≤0.4.

9. The positive active material precursor of claim 6, wherein in Chemical Formula 2, 0.6≤x1<0.96, 0<y1≤0.36, and 0.04≤z1≤0.07.

10. The positive active material precursor of claim 1, wherein the positive active material precursor has a spherical shape.

11. The positive active material precursor of claim 1, wherein the positive active material precursor has an average particle diameter (D50) of about 8 μm to about 15 μm.

12. The positive active material precursor of claim 1, wherein the core-shell particle is a secondary particle in which a plurality of primary particles is agglomerated.

13. A method of preparing a positive active material for a rechargeable lithium battery, the method comprising:
mixing the positive active material precursor of claim 1 with a lithium raw material, and
performing heat treatment.

14. A positive active material for a rechargeable lithium battery,
the positive active material having a form of a core-shell particle comprising a core and a shell around the core,
wherein the core comprises a lithium-nickel-manganese-based composite oxide comprising lithium, nickel, and manganese, and
the shell comprises a lithium-nickel-manganese-based composite oxide comprising lithium, nickel, manganese and a pillar element, and
the pillar element comprises at least one selected from the group consisting of Al, Mo, Ti, W, and Zr.

15. The positive active material of claim 14, wherein the core comprises the pillar element in an amount of about 0 mol % to less than about 2 mol % based on 100 mol % of a metal excluding lithium in the core.

16. The positive active material of claim 14, wherein the shell comprises the pillar element in an amount of about 1 mol % to about 7 mol % based on 100 mol % of a metal excluding lithium in the shell.

17. The positive active material of claim 14, wherein a value obtained by subtracting a content of the pillar element in the core from the content of the pillar element in the shell is about 1 mol % to about 7 mol %.

18. The positive active material of claim 14, wherein a thickness of the shell is about 20% to about 50% of a radius of the core-shell particle.

19. The positive active material of claim 14, wherein:
a difference between a molar concentration of nickel based on the total metal excluding lithium in the core and a molar concentration of nickel based on the total metal excluding lithium in the shell is greater than or equal to about 0 mol % and less than or equal to about 10 mol %, and
a difference between a molar concentration of manganese based on the total metal excluding lithium in the core and the molar concentration of manganese based on the total metal excluding lithium in the shell is greater than or equal to about 0 mol % and less than or equal to about 5 mol %.

20. The positive active material of claim 14, wherein:
the core comprises a lithium-nickel-manganese-based composite oxide represented by Chemical Formula 11, and
the shell comprises a lithium-nickel-manganese-based composite oxide represented by Chemical Formula 12:
LiNiₐMn_{b}M¹¹_{c}M¹²_{(1-a-b-c)}O₂, Chemical Formula 11
wherein, in Chemical Formula 11, M¹¹ is a pillar element that is at least one selected from Al, Mo, Ti, W, and Zr, M¹² is at least one element selected from the group consisting of B, Ba, Ca, Ce, Cr, Cu, F, Fe, Mg, Nb, P, S, Si, Sr, and V, 0.6≤a<1, 0<b≤0.4, and 0≤c<0.02,
LiNiₓMn_{y}M¹³_{z}M¹⁴_{(1-x-y-z)}O₂, Chemical Formula 12
wherein, in Chemical Formula 12, M¹³ is a pillar element that is at least one selected from Al, Mo, Ti, W, and Zr, M¹⁴ is at least one element selected from the group consisting of B, Ba, Ca, Ce, Cr, Cu, F, Fe, Mg, Nb, P, S, Si, Sr, and V, 0.6≤x<0.99, 0<y≤0.39, and 0.01≤z≤0.07, and
wherein, in Chemical Formula 11 and Chemical Formula 12, |a−x|≤0.1 and |b−y|≤0.05.

21. The positive active material of claim 20, wherein in Chemical Formula 12, 0.6≤x<0.96, 0<y≤0.36, and 0.04≤z≤0.07.

22. The positive active material of claim 14, wherein the positive active material has a spherical shape.

23. The positive active material of claim 14, wherein an average particle diameter (D50) of the positive active material is 8 μm to 15 μm.

24. The positive active material of claim 14, wherein the core-shell particle is a secondary particle in which a plurality of primary particles is agglomerated.

25. The positive active material of claim 14, wherein the positive active material comprises about 0 mol % to about 2 mol % of cobalt based on the total content of metals in the positive active material.
